(19) United States
(12) Patent Application Publication
(10) Pub. No.: US 2008/0051250 A1
(43) Pub. Date: Feb. 28, 2008

(54) Shift-position control apparatus and method for automatic transmission

(75) Inventor: Yuji Inoue, Nissin-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-Shi (JP)

(21) Appl. No.: 11/889,282

(22) Filed: Aug. 10, 2007

(30) Foreign Application Priority Data
Aug. 25, 2006 (JP) 2006-229374

(51) Int. Cl. B60W 10/10

(52) U.S. Cl. 477/34

(57) ABSTRACT

A shift-position control apparatus for an automatic transmission mounted in a vehicle includes a shift-position changing unit that moves a mechanical element using an actuator in response to an operation to change a shift-position to another shift-position instructed by the operation from among a plurality of shift-positions; a detection unit that detects the operating state of the shift-position changing unit; a malfunction determination unit that determines whether a malfunction has occurred in the shift-position changing unit based on the operating state during a reference time; and a setting unit that sets the reference time, which is used when a shift-position change that involves a change in the direction of power transfer is made, to a time that is shorter than the reference time, which is used when a shift-position change that does not involve a change in the direction of power transfer is made.

The disclosure of Japanese Patent Application No. 2006-229374 filed on Aug. 25, 2006 including the specification, drawings and abstract is incorporated herein by reference in its entirety.

### BACKGROUND OF THE INVENTION

1. Field of the Invention

The invention relates generally to a shift-position control apparatus and method for an automatic transmission, which changes shift-positions (shift ranges) of an automatic transmission using an actuator, for example, a motor. More specifically, the invention relates to a shift-position control apparatus and method for an automatic transmission, which appropriately deals with a malfunction that occurs when a shift-position change that involves a change in the direction of power transfer (for example, from Drive to Reverse, or from Reverse to Drive) is made.

2. Description of the Related Art

Automatic transmissions for vehicles are grouped into multi-speed automatic transmissions and continuously variable automatic transmissions. A multi-speed automatic transmission generally includes a fluid coupling, for example, a torque converter, and a speed-change gear mechanism. A continuously variable automatic transmission includes two pulleys of which the pulley-diameters are varied by hydraulic pressure, and a metal belt looped over these pulleys.

A multi-speed automatic transmission is connected to an engine via a fluid coupling, for example, a torque converter. The multi-speed automatic transmission includes a speed-change gear mechanism in which a plurality of power transfer paths may be formed. The multi-speed automatic transmission is structured such that the optimal power transfer path is automatically formed, namely, the optimal gear ratio (gear) is automatically selected in accordance with the accelerator pedal operation amount and the vehicle speed. In the multi-speed automatic transmission, clutches, brakes, and one-way clutches, which are all friction engaging elements, are engaged/released, in a predetermined manner, to select an appropriate gear.

A continuously variable automatic transmission is also connected to an engine via a fluid coupling, for example, a torque converter. For example, a belt-type continuously variable automatic transmission includes an endless metal belt and a pair of pulleys, and produces continuous speed ratios by continuously varying the pulley-diameters using hydraulic pressure. More specifically, the endless metal belt is looped over the input pulley fitted to the input shaft of the automatic transmission and the output pulley fitted to the output shaft of the automatic transmission. The input pulley and the output pulley each include a pair of sheaves. The width of a groove formed between these sheaves is continuously varied. Thus, the diameter of each of the loops formed by the endless metal belt looped over the input pulley and the output pulley is continuously varied. As a result, the rotational speed ratio between the input shaft and the output shaft, that is, the speed ratio is varied continuously.

A vehicle including either type of the automatic transmission described above is usually provided with a slide shift lever that is slid to a shift-position selected by a driver from among multiple shift-positions (e.g. Park, Reverse, Neutral, Drive). Accordingly, the driver recognizes the shift-position of the automatic transmission by visually checking the position of the shift lever in a slide groove.

A shift range signifies a range of gears of the automatic transmission, which are used when the vehicle is moving forward. Multiple forward gears are selectable in the automatic transmission. For example, in an automatic transmission having six forward gears and one reverse gear, when first range is selected, only first gear is selectable. When second range is selected, first gear and second gear are selectable. When third range is selected, first gear, second gear and third gear are selectable. When D range is selected, first to sixth gears are selectable.

Recently, not only such shift-position control apparatus provided with a slide shift lever but also a so-called “Shift-by-Wire” shift-position control apparatus has been used. Such Shift-by-Wire shift-position control apparatus detects a shift-position changing operation performed by a driver, using sensors and switches (sensors, etc.), and selects a shift-position from among multiple shift-positions based on detection signals from these sensors and switches. A selector for such Shift-by-Wire shift-position control apparatus is not limited to a slide shift lever. Instead of a slide shift lever, operating members such as a so-called joystick or a push button may be employed. In the case of a shift-position control apparatus provided with a joystick, the driver tilts a lever rightward/leftward and forward/rearward, whereby the shift-positions are changed.

Japanese Patent Application Publication No. JP-2004-125061 (JP-A-2004-125061) describes a technology related to a Shift-by-Wire shift-position control apparatus for an automatic transmission. JP-2004-125061 describes a control apparatus for an automatic transmission, which effectively prevents a vehicle behavior that does not appropriately reflect driver's intention by appropriately controlling the automatic transmission if a malfunction occurs in an actuator that drives a manual shaft. Usually, the manual shaft is rotated by the driver power supplied from the actuator to select. a shift-range position which reflects the driver's intention from among a plurality of shift-range positions. The control apparatus for an automatic transmission includes a target shift-range position command unit that has multiple shift-range positions corresponding to multiple shift-ranges of the automatic transmission, that selects one of the multiple shift-range positions as a target shift-range position in response to a shift-range position changing operation performed by a driver, and that converts the target shift-range position to an electric signal and outputs the electric signal as a target shift-range position signal; an actual shift-range changing unit that changes the actual shift-ranges of the automatic transmission based on the target shift-range position signal; a shift-range position detection unit that converts the actual shift-range position of the automatic transmission to an electric signal and detects the electric signal as a shift-range position signal; a shift malfunction determination unit that determines that a malfunction has occurred in the automatic transmission, when the target shift-range position signal differs from the actual shift-range position signal; and a power transfer path shutting-off unit that shuts off a power transfer path which extends from an output shaft of an engine through the automatic transmission to drive wheels, when the shift malfunction determination unit determines that a malfunction has occurred in the automatic transmission.

With the control unit for an automatic transmission, the actual shift-range position of the automatic transmission is detected, and the actual shift-range position is compared with the target shift-range position instructed by the operation of a shift-range position selection switch, which is performed by a driver. When the actual shift-range position differs from the target shift-range position, the shift malfunction determination unit -determines that a malfunction has occurred in the automatic transmission, for example, a malfunction has occurred in the actuator that drives the manual shaft. If it is determined that a malfunction has occurred, the power transfer path shutting-off unit shuts off the power transfer path that transfers the rotation of the engine to the drive wheels through the automatic transmission so that the rotation of the engine is not transferred to the driver wheels. Thus, it is possible to avoid the situation where the vehicle suddenly takes off or backs up against the driver's intention when the target shift-range position does not match the actual shift-range position. When the mismatch of target shift-range position and the actual shift-range position is eliminated by, for example, the operation of the shift-range position selection switch, which is performed by the driver, the control apparatus for an automatic transmission permits power transfer through the power transfer path again. Thus, the vehicle moves using the shift-range of the automatic transmission, which appropriately reflects the driver's intention.

The abovementioned control apparatus for an automatic transmission described in JP-A-2004-125061 compares the target shift-range position instructed by the operation of the shift-range position selection switch, which is performed by the driver, with the actual shift-range position. When the target shift-range position differs from the actual shift-range position, it is determined that a malfunction has occurred in the automatic transmission, for example, a malfunction has occurred in the actuator that drives the manual shaft. Namely, even in a shift-range position change that involves a change in the direction of power transfer, for example, a shift-range position change from D to R or from R to D (hereinafter, such shift-range position change will be referred to as a “shift-range position change that involves a change in the direction of power transfer”), the determination is made in the same manner as that when a shift-range position change that does not involve a change in the direction of power transfer is made. More specifically, when the vehicle is moved alternately forward and backward to go round a narrow curved road, shift-range position changes that involve changes in the direction of power transfer are repeatedly made. In such a case where shift-range position changes that involve changes in the direction of power transfer are made, if a determination is made in the same manner as that when a shift-range position change that does not involve a change in the direction of power transfer is made, it is not possible to determine the type of malfunction. Accordingly, the normal state needs to be reestablished in a uniform manner. For example, the power supply needs to be turned on again every time it is determined that a malfunction has occurred, which makes the operation complicated and increases the time required to go round the curved road. When the rotation of the manual shaft is only delayed it is not necessary to turn on the power supply again to reestablish the normal state. However, even in such a case, the power supply needs to be turned on again to, for example, reset the counter value of an encoder. Accordingly, it takes long to reestablish the normal state.

### SUMMARY OF THE INVENTION

The invention provides a “Shift-By-Wire” shift-position control apparatus and method for an automatic transmission, which moves a mechanical element using an actuator in response to an operation to change a shift-position to another shift-position instructed by an operation from among a plurality of shift-positions, and which promptly deals with a malfunction that occurs when a shift-position change that involves a change in the direction of power transfer is made.

A first aspect of the invention relates to a shift-position control apparatus for an automatic transmission mounted in a vehicle, which includes a shift-position changing unit that moves a mechanical element using an actuator in response to an operation to change a shift-position to another shift-position instructed by the operation from among a plurality of shift-positions; a detection unit that detects the operating state of the shift-position changing unit; a malfunction determination unit that determines whether a malfunction has occurred in the shift-position changing unit based on the operating state during a reference time; and a setting unit that sets the reference time, which is used when a shift-position change that involves a change in the direction of power transfer is made, to a time that is shorter than the reference time, which is used when a shift-position change that does not involve a change in the direction of power transfer is made. A second aspect of the invention relates to a shift-position control method for an automatic transmission, which includes steps that correspond to the elements of the shift-position control apparatus according to the first aspect of the invention.

With the shift-position control apparatus and method according to the above-described aspects of the invention, the shift-positions are changed through the “Shift-By-Wire” control for moving the mechanical element using the actuator in response to an operation to change a shift-position to another shift-position from among a plurality of shift-positions. The reference time, which is used when a shift-position change that involves a change in the direction of power transfer is made, to the time that is shorter than the reference time, which is used when a shift-position change that does not involve a change in the direction of power transfer is made. Accordingly, with the above-described shift-position control apparatus and method, it is possible to more promptly detect a malfunction that occurs when a shift-position change that involves a change in the direction of power transfer is made. Therefore, it is not necessary to turn on a power supply again after occurrence of the malfunction in order to reestablish the normal state. The normal state is promptly reestablished with a simple operation. It is possible to provide a “Shift-By-Wire” shift-position control apparatus and method for an automatic transmission, which promptly deals with a malfunction that occurs when a shift-position change that involves a change in the direction of power transfer is made.

### BRIEF DESCRIPTION OF THE DRAWINGS

The foregoing and further objects, features and advantages of the invention will become apparent from the following description of an example embodiment with reference to the accompanying drawings, wherein the same or corresponding portions will be denoted by the same reference numerals and wherein:

FIG. 1 is a block diagram showing the configuration of a shift-position control system according to an embodiment of the invention;

FIG. 2 is a view showing the configuration of a shift switch in FIG. 1;

FIG. 3 is a view showing the configuration of a shift-position control mechanism in FIG. 1;

FIG. 4 is a functional block diagram of a shift-position control apparatus according to the embodiment of the invention; and

FIG. 5A and FIG. 5B show a flowchart of the control routine executed by a SBW-ECU according to the embodiment of the invention.

### DETAILED DESCRIPTION OF AN EMBODIMENT

Hereafter, an embodiment of the invention will be described with reference to the accompanying drawings. In the description below, the same or corresponding components and steps will be denoted by the same reference numerals. The names and functions of the components and steps having the same reference numerals are also the same. Accordingly, detailed description on the components and steps having the same reference numerals will be provided only once below.

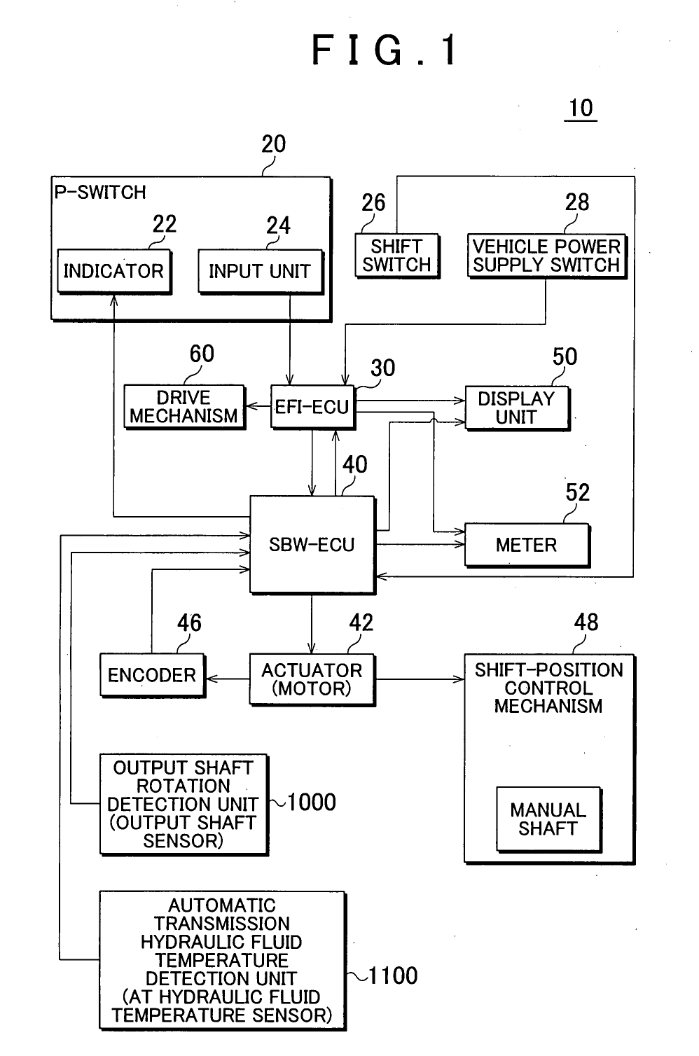

FIG. 1 shows the configuration of a shift-position control system 10 that functions as a shift-position control apparatus for an automatic transmission according to an embodiment of the invention. According to the embodiment of the invention, the shift-position control system 10 is controlled so as to promptly and appropriately deal with a malfunction which occurs when the shift-position is changed from Drive (hereinafter, referred to as “D”) to Reverse (hereinafter, referred to as “R”) or from R to D (hereinafter, such shift-position change will be referred to as “a shift-position change that involves a change in the direction of power transfer”). The embodiment of the invention makes it possible to promptly and appropriately deal with a malfunction that occurs in any shift-position changes that involve a change in the direction of power transfer. The shift control system 10 may function as the shift-position control apparatus according to the invention.

The shift-position control system 10 is used to change the shift-positions for a vehicle. The shift-position control system 10 includes a P-switch 20, a shift switch 26, a vehicle power supply switch 28, a vehicle control unit (hereinafter, referred to as an “EFI-ECU”) 30, a parking control unit (hereinafter, referred to as a “SBW (Shift-by-Wire)-ECU”) 40, an actuator (motor) 42, an encoder 46, a shift-position control mechanism 48, a display unit 50, a meter 52, and a drive mechanism 60. The shift-position control system 10 functions as a Shift-by-Wire shift-position changing system that changes the shift-positions under electric control. More specifically, the shift-position control mechanism 48 is driven by the actuator 42 to change the shift-positions.

The vehicle power supply switch 28 is used to change the on/off state of an electric power supply for a vehicle. Any type of switch, for example, an ignition switch may be employed as the vehicle power supply switch 28. An instruction that the vehicle power supply switch 28 receives from, for example, a driver is transmitted to the EFI-ECU 30. For example, when the vehicle power supply switch 28 is turned on, electric power is supplied from an auxiliary battery (not shown), whereby the shift-position control system 10 is actuated.

The P-switch 20 is used to change the shift-position between Park (hereinafter, referred to as “P”) and any one of the shift-positions other than P (i.e., R, D, and Neutral (hereinafter, referred to as “N”)) (hereinafter, these three shift-positions R, D and N will be collectively referred to as “Non-P”). The P-switch 20 includes an indicator 22 that indicates the current shift-position (P or Non-P) to the driver, and an input unit 24 that receives an instruction from the driver. The driver inputs an instruction to change the shift-position to P in the P-switch 20 through the input unit 24. The input unit 24 may be a momentary switch. The instruction from the driver, which is received by the input unit 24, is transmitted to the EFI-ECU 30, and also to the SBW-ECU 40 through the EFI-ECU 30. A component other than the P-switch 20 may be used to change the shift-position from Non-P to P.

The SBW-ECU 40 controls the actuator 42 that drives the shift-position control mechanism 48 to change the shift-position between P and Non-P. The SBW-ECU 40 causes the indicator 22 to indicate the current shift-position (P or Non-P). If the driver presses the input unit 24 when the shift-position is in Non-P, the SBW-ECU 40 changes the shift-position to P, and causes the indicator 22 to indicate that the current shift-position is in P.

The actuator 42 is formed of a switched reluctance motor (hereinafter, referred to as a “SR motor”), and drives the shift-position control mechanism 48 in accordance with an instruction from the SBW-ECU 40. The encoder 46 rotates together with the actuator 42, and detects the rotational state of the SR motor. The encoder 46 is a rotary encoder that outputs an A-phase signal, a B-phase signal and a Z-phase signal. The SBW-ECU 40 receives a signal from the encoder 46 to determine the rotational state of the SR motor, and controls a supply of electric power used to drive the SR motor.

The shift switch 26 is used to change the shift-position to D, R, N, or Brake (hereinafter, referred to as “B”). When the shift-position is in P, the shift switch 26 is used to change the shift-position from P to Non-P. An instruction from the driver, which is received by the shift switch 26, is transmitted to the EFI-ECU 30. The EFI-ECU 30 executes the control to change the shift-positions in the drive mechanism 60 in accordance with the instruction from the driver, and causes the meter 52 to indicate the shift-position. In the embodiment of the invention, the drive mechanism 60 is formed of a continuously variable speed-change mechanism. Alternatively, the drive mechanism 60 may be formed of a multi-speed speed-change mechanism.

The EFI-ECU 30 comprehensively controls the operation of the shift-position control system 10. The display unit 50 indicates an instruction, an alert (including a notification of occurrence of a malfunction, described in detail later), etc. provided from the EFI-ECU 30 or the SBW-ECU 40 to the driver. The meter 52 indicates the conditions of the vehicle components and the current shift-position.

The SBW-ECU 40 is connected to an output shaft rotation detection unit (hereinafter, referred to as an “output shaft sensor”) 1000 such that the rotation of a manual shaft is detected even if the encoder 46 itself malfunctions, noise is superimposed on a signal transmitted from the encoder 46 to the SBW-ECU 40, or a supply of electricity to a coil of the encoder 46 is shut off. The viscosity of the hydraulic fluid for the automatic transmission varies depending on the temperature thereof (hereinafter, referred to as the “hydraulic fluid temperature” where appropriate). As the hydraulic fluid temperature becomes lower, the hydraulic fluid becomes higher in viscosity and lower in fluidity. Accordingly, even if a malfunction-dealing process for actuating a hydraulic circuit for the automatic transmission is executed, friction engaging elements such as clutches and brakes of the automatic transmission are not engaged/released promptly. In the malfunction-dealing process, for example, the shift-position is changed to N. Accordingly, the shift changing apparatus for a transmission sets a malfunction reference time, described in detail later, to a shorter time as the hydraulic fluid temperature becomes lower. Therefore, the SBW-ECU 40 is connected to an automatic transmission hydraulic fluid temperature detection unit (hereinafter, referred to as an “AT hydraulic fluid temperature sensor”) 1100 that detects the temperature of the hydraulic fluid for the automatic transmission.

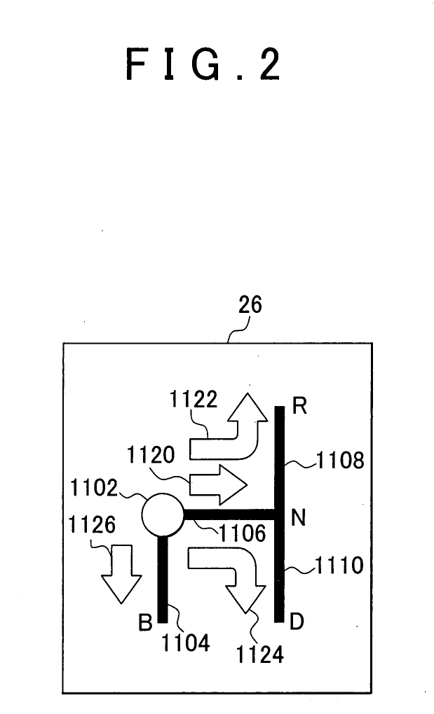

As shown in FIG. 2, the shift switch 26 is formed of, for example, a shift lever 1102, a first groove 1104, a second groove 1106, a third groove 1008, and a fourth groove 1110. The shift lever 1102 is slid along these grooves 1104, 1106, 1108 and 1110.

The shift lever 1102 is slid along the first groove 1104 until reaching the lower end thereof and held at the lower end for a predetermined time or longer by the driver, whereby the shift-position is set to B. In this case, the shift lever 1102 is moved as indicated by an arrow 1126.

The shift lever 1102 is slid along the second groove 1106 until reaching the right end thereof and held at the right end for a predetermined time or longer by the driver, whereby the shift-position is set to N. In this case, the shift lever 1102 is moved as indicated by an arrow 1120.

The shift lever 1102 is slid along the second groove 1106 until reaching the right end thereof, then slid along the third groove 1108 until reaching the upper end thereof, and held at the upper end for a predetermined time or longer by the driver, whereby the shift-position is set to R. In this case, the shift lever 1102 is moved as indicated by an arrow 1122.

The shift lever 1102 is slid along the second groove 1106 until reaching the right end thereof, then slid along the fourth groove 1110 until reaching the lower end thereof, and held at the lower end for a predetermined time or longer by the driver, whereby the shift-position is set to D. In this case, the shift lever 1102 is moved as indicated by an arrow 1124.

In FIG. 2, the shift lever 1102 is at the reference position at which the driver's hand is apart from the shift lever 1102. Namely, as shown in FIG. 2, if the shift lever 1102 is moved from the reference position as indicated by the arrow 1120, the shift-position is changed to N. If the shift lever 1102 is moved as indicated by the arrow 1122, the shift-position is changed to R. If the shift lever 1102 is moved from the reference position as indicated by the arrow 1124, the shift-position is changed to D. If the shift lever 1102 is moved from the reference position as indicated by the arrow 1126, the shift-position is changed to B at which the vehicle moves forward and engine braking is applied. The description concerning B will not be provided below.

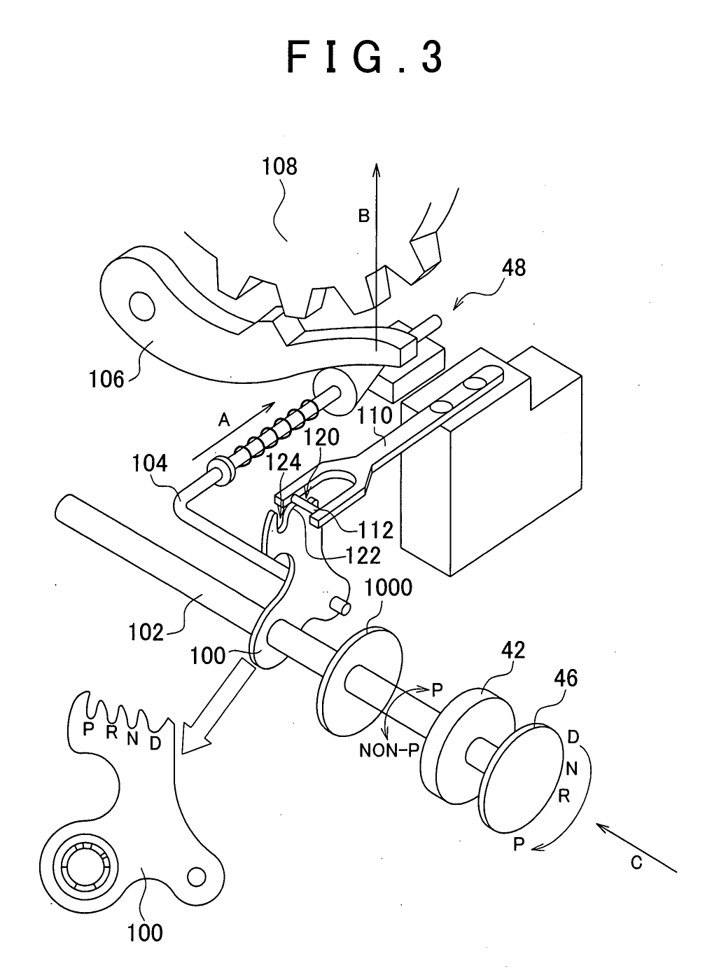

FIG. 3 shows the configuration of the shift-position control mechanism 48. The shift-positions include P, and Non-P including R, N, and D. Non-P may include, in addition to D, D1 at which first gear is always selected and D2 at which first or second gear (or only second gear) is always selected.

The shift-position control mechanism 48 includes a manual shaft 102 that is rotated by the actuator 42, a detent plate 100 that rotates along with the manual shaft 102, a rod 104 that operates in accordance with the rotation of the detent plate 100, a parking gear 108 that is fixed to the output shaft of a transmission (not shown), a parking gear locking pawl 106 that is used to lock the parking gear 108, a detent spring 110 that restricts the rotation of the detent plate 100 to fix the shift-position at a predetermined shift-position, and a roller 112. The manual shaft 102 functions as a mechanical element according to the invention.

The detent plate 100 is driven by the actuator 42 to change the shift-positions. The manual shaft 102, the detent plate 100, the rod 104, the detent spring 110 and the roller 112 serve, in combination, as a shift-position changing mechanism. The encoder 46 obtains a discrete value corresponding to the rotational amount of the actuator 42. The shift-position changing mechanism functions as shift-position changing means or a shift-position changing unit according to the invention.

In the perspective view in FIG. 3, only two of the indentations formed in the detent plate 100 (an indentation 124 corresponding to P and an indentation 120 corresponding to one of Non-P) are shown. However, the detent plate 100 actually has four indentations corresponding to D, N, R and P, as shown in the enlarged plane view of the detent plate 100 in FIG. 3.

FIG. 3 shows the state in which the shift-position is in Non-P. In this state, because the parking gear locking pawl 106 does not lock the parking gear 108, the rotation of the drive shaft of the vehicle is not interfered with. If the manual shaft 102 is then rotated in the clockwise direction, when viewed in the direction of the arrow C, by the actuator 42, the rod 104 is pressed via the detent plate 100 in the direction of the arrow A in FIG. 3, whereby the parking gear locking pawl 106 is pushed up in the direction of the arrow B in FIG. 3 by a tapered portion provided at the tip of the rod 104. As the detent plate 100 rotates, the roller 112 of the detent spring 110, which is positioned at one of the four indentations formed at the top portion of the detent plate 100, namely, the indentation 120 corresponding to Non-P climbs over a crest 122 and moves into the other indentation, namely, the indentation 124 corresponding to P. The roller 112 is fitted to the detent spring 110 so as to be rotatable about its axis. When the detent plate 100 rotates until the roller 112 reaches the indentation 124 corresponding to P, the parking gear locking pawl 106 is pushed up to a position at which the parking gear locking pawl 106 is engaged with the parking gear 108. Thus, the drive shaft of the vehicle is mechanically fixed, and the shift-position is changed to P.

In the shift-position control system 10, the SBW-ECU 40 controls the rotational amount of the actuator 42 so that the impact caused when the roller 112 of the detent spring 110 drops into an indentation after climbing over the crest 122 is reduced to reduce the load placed on the shift-position changing mechanism including the detent plate 100, the detent spring 110 and the manual shaft 102 when the shift-positions are changed.

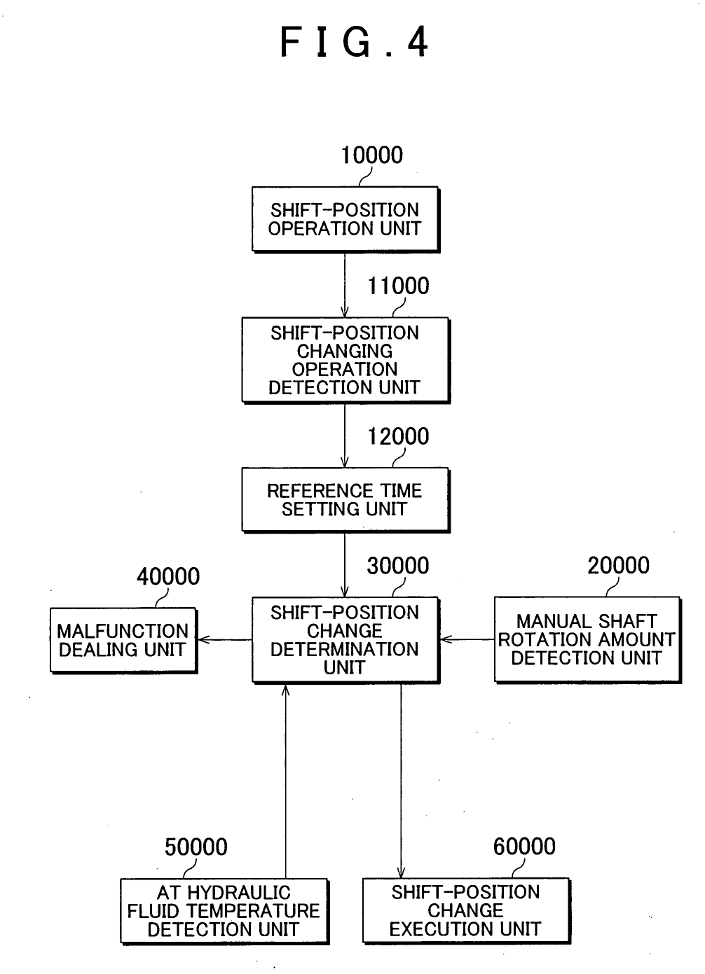

The functional block diagram of the shift-position control apparatus will be described with reference to FIG. 4. As shown in FIG. 4, the shift-position control apparatus includes a shift-position operation unit 10000 operated by the driver to change the shift-positions (corresponding to, for example, the shift switch 26); a shift-position changing operation detection unit 11000 that is connected to the shift-position operation unit 10000 and that detects the shift-position changing operation performed by the driver; a reference time setting unit 12000 that sets a reference time, which varies depending on whether a shift-position change involves a change in the direction of power transfer, based on the output from the shift-position changing operation detection unit 11000; a shift-position change determination unit 30000 that executes control to make an instructed shift-position change and that determines, based on the reference time, whether a malfunction has occurred when the shift-positions are changed; and a shift-position change execution unit 60000 (corresponding to, for example, the actuator 42 and the shift-position control mechanism 48 in FIG. 1) that is controlled by the shift-position change determination unit 30000. The shift-position control apparatus may include a unit that determines whether a shift-position change involves a change in the direction of power transfer based on the output from the shift-position changing operation detection unit 11000.

In addition, the shift-position change determination unit 30000 is connected to an AT hydraulic fluid temperature detection unit 50000 that detects the temperature of the hydraulic fluid for the automatic transmission (corresponding to the AT hydraulic fluid temperature sensor 1100 in FIG. 1). The shift-position change determination unit 30000 corrects the reference time based on the temperature of the hydraulic fluid for the automatic transmission. The shift-position change determination unit 30000 is connected to a manual shaft rotation amount detection unit 20000 (corresponding to the encoder 46 and the output shaft sensor 1000 in FIG. 1). The shift-position change determination unit 30000 determines that a malfunction has occurred if a signal from the manual shaft rotation amount detection unit 20000 does not change for a reference time or longer.

The shift-position change determination unit 30000 is connected to a malfunction dealing unit 40000 that changes the shift-position to N if a malfunction occurs when a shift-position change that involves a change in the direction of power transfer is made. The malfunction dealing unit 40000 may store the information that a malfunction has occurred when the shift-positions are changed, as diagnostic information.

The shift-position control system 10 that functions as the shift-position control apparatus having the functions described above may be implemented by hardware formed mainly of a digital circuit or an analog circuit. Alternatively, the shift-position control system 10 may be implemented by a CPU (Central Processing Unit) and memory that are included in an ECU, and software mainly formed of a program read from the memory and executed by the CPU. Generally, implementing the shift-position control system 10 using hardware offers an advantage in the operational speed, and implementing the shift-position control system 10 using software offers an advantage in ease of design change. The following description will be provided on the assumption that the shift-position control system 10 is implemented using software.

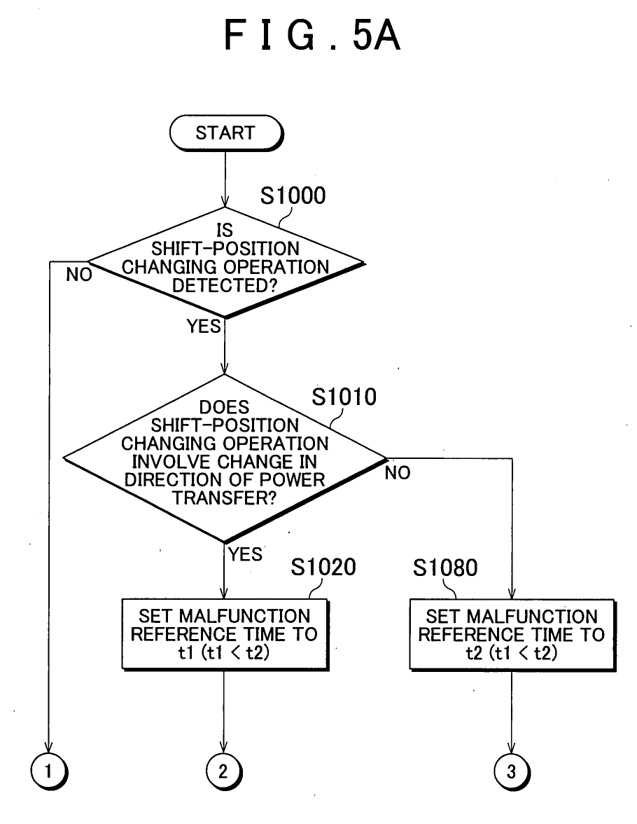

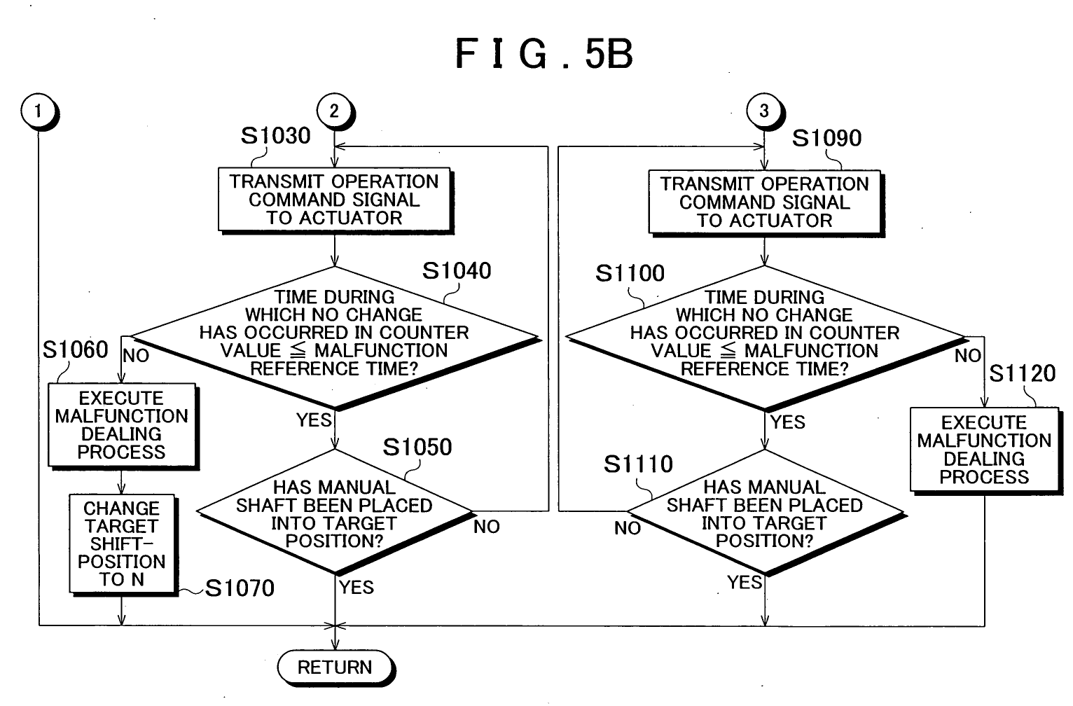

The control routine executed by the SBW-ECU 40 of the shift-position control system 10 will be described with reference to FIG. 5A and FIG. 5B. The control routine is periodically executed at predetermined time intervals.

In step (hereinafter, simply referred to as “S”) 1000, the SBW-ECU 40 determines whether a shift-position changing operation is detected. At this time, the SBW-ECU 40 makes a determination based on a signal received from the shift switch 26. If it is determined that a shift-position changing operation is detected (“YES” in S1000), S1010 is executed. On the other hand, if it is determined that a shift-position changing operation is not detected (“NO” in S1000), the control routine ends.

In S1010, the SBW-ECU 40 determines whether the detected shift-position changing operation involves a change in the direction of power transfer. If it is determined that the shift-position changing operation involves a change in the direction of power transfer (“YES” in S1010), S1020 is executed. On the other hand, if it is determined that the shift-position changing operation does not involve a change in the direction of power transfer (“NO” in S1010), S1080 is executed.

In S1020, the SBW-ECU 40 sets the malfunction reference time to time t1. Time t1 is shorter than time t2 which is described in detail later.

In S1030, the SBW-ECU 40 transmits an operation command signal to the actuator 42 that drives the shift-position control mechanism 48 to make a shift-position change that involves a change in the direction of power transfer.

In S1040, the SBW-ECU 40 determines whether the time, during which no change has occurred in a value of a counter that measures the rotational amount of the manual shaft 102, is equal to or shorter than the malfunction reference time, based on a signal received from the encoder 46 or the output shaft sensor 1000. If it is determined that the time during which no change has occurred in the counter value is equal to or shorter than the malfunction reference time (“YES” in S1040), S1050 is executed. On the other hand, if it is determined that the time during which no change has occurred in the counter value is longer than the malfunction reference time (“NO” in S1040), S1060 is executed.

In S1050, the SBW-ECU 40 determines, based on the signal received from the encoder 46 or the output shaft sensor 1000, whether the manual shaft 102 has been placed into the target position corresponding to D or the target position corresponding to R and the shift-position change has been completed. If it is determined that the manual shaft has been placed into the target position and the shift-position change has been completed (“YES” in S1050), the control routine end. On the other hand, if it is determined that the manual shaft has not been placed into the target position and the shift-position change has not been completed (“NO” in S1050), S1030 is executed again.

In S1060, the SBW-ECU 40 executes the malfunction dealing process, for example, engages/releases the clutches and brakes, which are the friction engaging elements of the automatic transmission. At this time, if the temperature of the hydraulic fluid for the automatic transmission is high, the friction engaging elements are engaged/released promptly. On the other hand, if the temperature of the hydraulic fluid is low, it takes longer to engage/release the friction engaging elements. Accordingly, the time required to execute the malfunction dealing process when the temperature of the hydraulic fluid for the automatic transmission is low is longer than that when the hydraulic fluid temperature is high. Therefore, correction is made such that the malfunction reference time used when the hydraulic fluid temperature is low is shorter than the malfunction reference time used when the hydraulic fluid temperature is high.

In S1070, the SBW-ECU 40 operates the actuator 42 according to a control routine that differs from this control routine to change the target shift-position to N. If the rotation of the manual shaft 102 is delayed due to a factor that differs from a malfunction in the hardware, the driver operates the shift switch 26 again to change the shift-position to D or R, whereby the normal state is reestablished. When the actuator 42 is inoperative, the shift-position cannot be changed to N. Accordingly, the current shift-position is maintained.

In S1080, the SBW-ECU 40 sets the malfunction reference time to time t2. Time t2 is longer than time to described above.

In S1090, the SBW-ECU 40 transmits an operation command signal to the actuator 42 that drives the shift-position control mechanism 48 in order to make a shift-position change that does not involve a change in the direction of power transfer.

In S1100, the SBW-ECU 40 determines whether the time, during which no change has occurred in a value of the counter that measures the rotational amount of the manual shaft 102, is equal to or shorter than the malfunction reference time based on a signal received from the encoder 46 or the output shaft sensor 1000. If it is determined that the time, during which no change has occurred in the counter value, is equal to or shorter than the malfunction reference time (“YES” in S1100), S1110 is executed. On the other hand, if it is determined that the time, during which no change has occurred in the counter value, is longer than the malfunction reference time (“NO” in S1100), S1120 is executed.

In S1110, the SBW-ECU 40 determines whether the manual shaft 102 has been placed into the target position corresponding to the shift-position instructed by the driver and the shift-position change has been completed based on the signal received from the encoder 46 or the output shaft sensor 1000. If it is determined that the manual shaft 102 has been placed into the target position and the shift-position change has been completed (“YES” in S1110), the control routine ends. On the other hand, if it is determined that the manual shaft 102 has not been placed into the target position and the shift-position change has not been completed (“NO” in S1110), S1090 is executed again.

In S1120, which is similar to S1060, the SBW-ECU 40 executes the malfunction dealing process, for example, engages/releases the clutches and brakes that are the friction engaging elements of the automatic transmission.

The malfunction reference time that is set to time t1 or time t2 is corrected by the shift-position change determination unit 30000 based on the temperature of the hydraulic fluid for the automatic transmission. At this time, correction is made such that the malfunction reference time is set to a shorter time as the hydraulic fluid temperature is lower.

Next, the operation of the shift-position control system 10 that functions as the shift-position control apparatus for an automatic transmission, which has the configuration described above will be described.

If a shift-position change that involves a change in the direction of power transfer is made by the driver (“YES” in S1010), the SBW-ECU 40 sets the malfunction reference time to time t1 that is shorter than time t2 which is set as the malfunction reference time used when a shift-position change that does not involve a change in the direction of power transfer is made.

If the SBW-ECU 40 transmits an operation command (the target position is R or D) to the actuator 42 (S1030), and then determines that the time, during which no change has occurred in at least one of the counter value of the encoder 46 and the value detected by the output shaft sensor 1000, becomes longer than the malfunction reference time to (“NO” in S1040), the SBW-ECU 40 determines that some sort of malfunction has occurred in the shift-position control system 10, and executes the malfunction dealing process (S1060). In addition, the target position is changed to N according to the control routine that differs from the control routine executed by the SBW-ECU 40 (S1070).

Thus, the SBW-ECU 40 more promptly detects a malfunction that occurs when a shift-position change that involves a change in the direction of power transfer is made. In addition, because the target shift-position is changed to N, the driver need not turn on the power supply again after occurrence of a malfunction in order to reestablish the normal state. The driver only need to operate the shift switch 26 again to change the shift-position to R or D in order to reestablish the normal state.

With the thus configured shift-position control apparatus, a malfunction, which occurs when a shift-position change that involves a change in the direction of power transfer is made, is promptly detected, and the electric power supply need not be turned on again to reestablish the normal state, in the Shift-by-Wire shift-position control system. As a result, the normal state is reestablished promptly and easily.

In S1040 and S1100, the SBW-ECU 40 may compare the time, during which a counter value is less than a threshold value, with the malfunction reference time instead of comparing the time, during which no change has occurred in the counter value, with the malfunction reference time.

The shift-position control apparatus according to the invention may be applied to any one of an automatic transmission that executes the gear control in which the gear corresponding to the shift-position selected by the driver is used, and an automatic transmission that executes the shift-range control in which the gear corresponding to the shift-position selected by the driver and the gears lower than the selected gear are all used.

While the invention has been described with reference to an example embodiment thereof, it is to be understood that the invention is not limited to the example embodiment or constructions. To the contrary, the invention is intended to cover various modifications and equivalent arrangements. In addition, while the various elements of the example embodiment are shown in various combinations and configurations, which are exemplary, other combinations and configurations, including more, less or only a single element, are also within the scope of the invention.

What is claimed is:

1. A shift-position control apparatus for an automatic transmission mounted in a vehicle, comprising:
a shift-position changing unit that moves a mechanical element using an actuator in response to an operation to change a shift-position to another shift-position instructed by the operation from among a plurality of shift-positions;
a detection unit that detects an operating state of the shift-position changing unit;
a malfunction determination unit that determines whether a malfunction has occurred in the shift-position changing unit based on the operating state during a reference time; and
a setting unit that sets the reference time, which is used when a shift-position change that involves a change in a direction of power transfer is made, to a time that is shorter than the reference time, which is used when a shift-position change that does not involve a change in the direction of power transfer is made.

2. The shift-position control apparatus for an automatic transmission according to claim 1, wherein
the detection unit detects the operating state based on a rotational amount of the mechanical element, and
the malfunction determination unit determines that a malfunction has occurred in the shift-position changing unit, if no change has occurred in the rotational amount or if a time during which the rotational amount is less than a predetermined value is longer than the reference time.

3. The shift-position control apparatus for an automatic transmission according to claim 1, further comprising:
a unit that detects a temperature of a hydraulic fluid for the automatic transmission, wherein
the setting unit sets the reference time, which is used when the detected temperature of the hydraulic fluid is low, to a time that is shorter than the reference time, which is used when the detected temperature of the hydraulic fluid is high.

4. The shift-position control apparatus for an automatic transmission according to claim 1, further comprising:
a unit that determines, based on the operating state, whether a shift-position change involves a change in the direction of power transfer.

5. The shift-position control apparatus for an automatic transmission according to claim 1, further comprising:
a unit that sets a target shift-position of the automatic transmission to a predetermined shift-position when the malfunction determination unit determines that a malfunction has occurred when a shift-position change that involves a change in the direction of power transfer is made.

6. The shift-position control apparatus for an automatic transmission according to claim 5, wherein
the unit sets the target shift-position of the automatic transmission to the predetermined shift-position by releasing or engaging a friction engaging element of the automatic transmission.

7. The shift-position control apparatus for an automatic transmission according to claim 5, wherein
the predetermined shift-position is Neutral or Park.

8. A shift-position control method for an automatic transmission mounted in a vehicle, comprising:
moving a mechanical element using an actuator in response to an operation to change a shift-position to another shift-position instructed by the operation from among a plurality of shift-positions;
detecting a shift-position changing state;
determining whether a malfunction has occurred when the shift-positions are changed based on the shift-position changing state during a reference time; and
setting the reference time, which is used when a shift-position change that involves a change in a direction of power transfer is made, to a time that is shorter than the reference time, which is used when a shift-position change that does not involve a change in the direction of power transfer is made.

9. The shift-position control method for an automatic transmission according to claim 8, wherein
the shift-position changing state is detected based on a rotational amount of the mechanical element, and
it is determined that a malfunction has occurred when the shift-positions are changed, if no change has occurred in the rotational amount or if a time during which the rotational amount is less than a predetermined value is longer than the reference time.

10. The shift-position control method for an automatic transmission according to claim 8, further comprising:
detecting a temperature of a hydraulic fluid for the automatic transmission, wherein
the reference time, which is used when the detected temperature of the hydraulic fluid is low, is set to a time that is shorter than the reference time, which is used when the detected temperature of the hydraulic fluid is high.

11. The shift-position control method for an automatic transmission according to claim 8, further comprising:
determining, based on the shift-position changing state, whether a shift-position change involves a change in the direction of power transfer.

12. The shift-position control method for an automatic transmission according to claim 8, further comprising:
setting a target shift-position of the automatic transmission to a predetermined shift-position when it is determined that a malfunction has occurred when a shift-position change that involves a change in the direction of power transfer is made.

13. The shift-position control method for an automatic transmission according to claim 12, wherein
the target shift-position of the automatic transmission is set to the predetermined shift-position by releasing or engaging a friction engaging element of the automatic transmission.

14. The shift-position control method for an automatic transmission according to claim 12, wherein
the predetermined shift-position is Neutral or Park.
